(19) United States
(12) Patent Application Publication
(10) Pub. No.: US 2014/0350896 A1
(43) Pub. Date: Nov. 27, 2014

(54) Digital Sensor

(71) Applicant: Thorsten Knittel, Pentling (GB)

(72) Inventor: Thorsten Knittel, Pentling (GB)

(21) Appl. No.: 14/361,518

(22) PCT Filed: Nov. 30, 2012
(86) PCT No.: PCT/EP2012/074017

§ 371 Date: May 29, 2014

(30) Foreign Application Priority Data
Dec. 2, 2011 (DE) 10 2011 087 677.4

(51) Int. Cl. G01D 9/02

(52) U.S. Cl. CPC G01D 9/02
USPC 702/189

(57) ABSTRACT

A digital sensor has a sensor element, a digital section, a sample-and-hold stage and an output stage, and storage storing electrical energy, each of which are supplied with electrical energy by a power supply. In the event of a failure of the power supply, the sample-and-hold stage and the output stage are provided with power by the storage storing electrical energy, such that the measurement value most recently stored in the sample-and-hold stage is provided in the signal line by the output stage until the failure of the power source has ended and a new measurement value is stored in the sample-and-hold stage. No electric power is supplied to the sensor element by the storage storing electrical energy in the event of a failure of the power supply.

### CROSS-REFERENCE TO RELATED APPLICATIONS

This is a U.S. national stage of application No. PCT/EP2012/074017, filed on 30 Nov. 2012, which claims priority to the German Application No. 10 2011 087 677.4, filed 2 Dec. 2011, the content of both incorporated herein by reference.

### BACKGROUND OF THE INVENTION

1. Field of the Invention

The invention relates to a digital sensor comprising a sensor element, a digital part, a sample-and-hold stage and an output stage and storage for storing electrical energy, wherein electrical energy is supplied to the sensor element, the digital part, the sample-and-hold stage, the output stage and the storage by a power supply. The sensor makes available, in digital form, the measured value of a downstream electronic circuit, which measured value has been determined by the sensor element and digitized and/or evaluated by the digital part, at a sensor output.

2. Related Art

Sensors which can detect a large number of physical variables in the form of measured values and contribute to a form of operation of motor vehicles which is safer, more efficient and more convenient have been used for many years in the automotive sector, for example. The physical variables are first detected as analog measured values. For example, the detection of the mass flow and of the temperature of a flow of fluid, is of high importance, in particular in the automotive industry, since these variables are required for optimized control of internal combustion engines in motor vehicles. The values determined by sensors for detecting the mass flow and the temperature of a flow of fluid have also hitherto been made available in analog form to the motor control device in the motor vehicle. Analog signals have the disadvantage, however, that they are susceptible to faults and can be considerably distorted by electromagnetic interference fields, for example. Therefore, digitization of the analog measured values determined by the sensor elements is still advantageous in the sensor itself.

This is performed using analog-to-digital converters, which can be arranged in the sensor itself in a digital part.

In the event of a failure of the power supply to the sensor, however, the digital sensors have also proven to be problematic since, immediately after the power failure, a digital signal is no longer available and the downstream electronic devices, as a result of the lack of measured values, switch to the emergency operation mode, which generally results in a substantially impaired performance of the equipment to be controlled. In addition, following the interruption to the current, a reconfiguration of the digital sensor is necessary, which likewise requires a not inconsiderable amount of time. During this time period, no usable measured values of the sensor are present.

In the case of sensors with an analog operation, this problem is solved by a capacitor of greater or lesser magnitude in the feedline of the power supply, which capacitor supplies electrical energy for a certain amount of time to provide a continued supply even in the case of a current interruption. If the energy from the capacitor in the feedline of the power supply is no longer sufficient, the sensor element ends the measurement of the corresponding physical variable. In the case of analog sensors, however, a capacitor is likewise provided in the line of the sensor output, which capacitor maintains the most recently detected analog measured value for a certain period of time after failure of the sensor element and then slowly loses the applied voltage, which is proportional to the measured value. Thus, the analog sensor still makes available a measured value for a relatively long period of time after the interruption of the supply current at the sensor output, which measured value comes close to the last measured value detected by the sensor element. As soon as the supply of the supply current to the sensor is produced again, the sensor produces new measured values without undergoing the initialization process necessary in the case of the digital sensor.

Even in the case of sensors with a digital operation, the supply of energy to the sensor can be maintained in the case of an interruption to the power supply by a capacitor with a greater or lesser magnitude in the feedline of the power supply. The capacitor in the feedline of the power supply also ensures continued supply of electrical energy for a certain period of time even during a current interruption. Since, however, many sensor elements (for example air-flow meters on the basis of hot film elements) consume a very large amount of electrical energy, the supply of electrical energy in the capacitor in the feedline of the power supply is exhausted quickly. Since the digital sensor makes available the measured values with respect to the physical variables in digital form (i.e., as a bit sequence, for example) at its sensor output, a capacitor in the line of the sensor output cannot maintain the last-measured signal. Therefore, as soon as the electrical energy from the capacitor in the feedline of the power supply has been exhausted after the interruption to the supply current, the entire sensor disintegrates and there is no longer any measured value at all available to the downstream electronics. In such situations, an emergency program starts up in the downstream electronics, which results in substantially impaired performances of the equipment being controlled. In addition, restarting of a disconnected digital sensor takes a relatively long period of time, and therefore the emergency program is required for a relatively long period of time.

### SUMMARY OF THE INVENTION

An object of the invention is to address the problem of specifying a digital sensor which provides measured values usable for as long as possible for the physical variable to be measured even after an interruption to the supply of supply current.

This problem is solved according to the invention by the features described herein.

### BRIEF DESCRIPTION OF THE DRAWINGS

The invention allows numerous embodiments. For a further explanation of the basic principle of the invention, one of these embodiments is illustrated in the drawings and will be described below. In the drawings:

FIG. 1 shows an analog sensor in a schematized illustration;

FIG. 2 shows a digital sensor in a schematized illustration;

FIG. 3 shows a digital sensor according to the invention; and

FIG. 4 shows a digital sensor comprising a gas sensor element.

### DETAILED DESCRIPTION OF THE PRESENTLY PREFERRED EMBODIMENTS

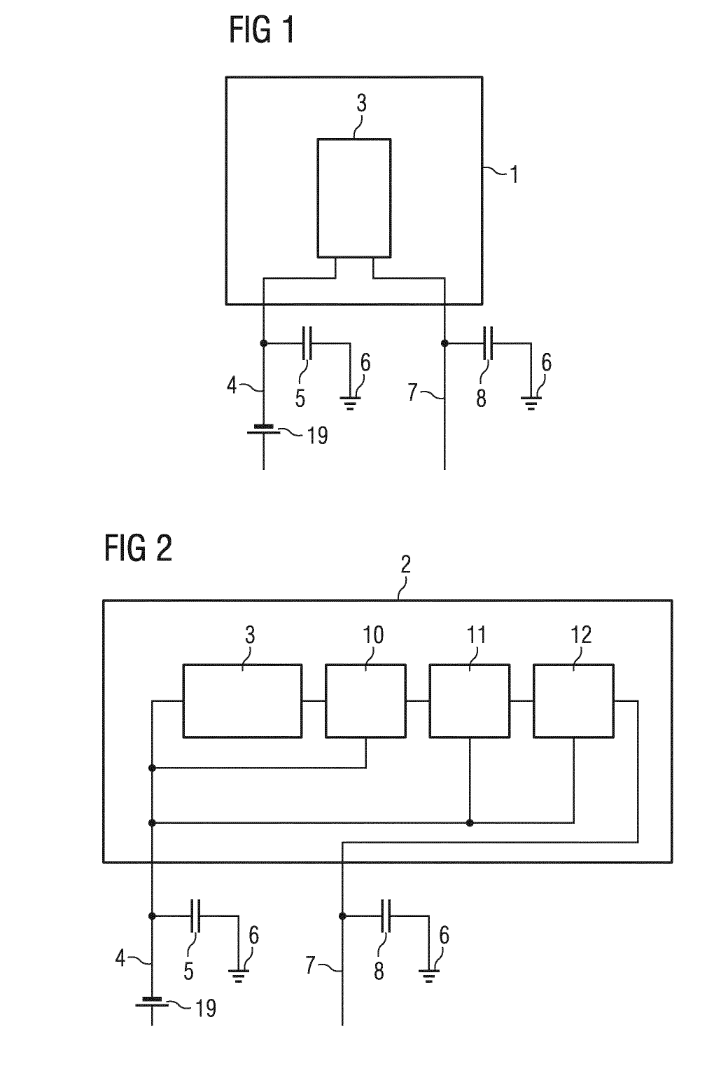

FIG. 1 shows an analog sensor 1 comprising a sensor element 3 in a schematized illustration. The sensor element 3 is connected to a power supply line 4, which is connected to a power supply 19. A first capacitor 5, which isolates the power supply line 4 from a ground 6, is connected to the power supply line 4. This first capacitor 5 is charged by the power supply 19. The first capacitor 5 can be provided with a relatively high capacitance, with the result that it can store a large quantity of electrical energy. If the power supply 19 fails or breaks down temporarily, the electrical energy stored in the first capacitor 5 can be used for supplying the sensor element 3. Thus, the sensor 1 can continue to pick up measured values even in the event of a failure of the power supply 19 and make these measured values available to downstream electronics (not illustrated here), for example a motor control device in a motor vehicle, over the signal line 7.

Since the supply of electrical energy in the first capacitor 5 is limited, the analog sensor 1 can only continue to operate and detect measured values for a certain period of time after the failure of the power supply 19. If the supply of electrical energy in the first capacitor 5 is exhausted, the sensor element 3 can no longer be operated and it is then also no longer possible for any signals to be provided to downstream electronics. In order nevertheless to make available a measured value to the downstream electronics which corresponds largely to the last measured value of the sensor element 3, a second capacitor 8 is connected to the signal line 7, which second capacitor in this example is connected between the signal line and ground 6. This second capacitor 8 will assume an electrical potential which largely corresponds to the measured value which is measured by the sensor element 3 and is provided as voltage value to the signal line 7. If, however, the power supply 19 has failed and the supply of electrical energy in the first capacitor 5 has been exhausted, the sensor element 3 no longer provides any measured values to the signal line 7. Nevertheless, the potential provided by the second capacitor 8, which largely corresponds to the last voltage value and therefore the last measured value of the sensor element 3, is present at the signal line 7. The potential provided by the second capacitor 8 will thereafter drop only slowly and come close to the ground potential, whereby a signal is present at the signal line 7 for a certain period of time even after failure of the sensor element 3, which signal largely corresponds to the last signal which the sensor element 3 produced. For this purpose, the second capacitor 8 in the signal line 7 in the case of the analog sensor 2 has a time constant of approximately 10 to 100 μsec, and the capacitance of this capacitor is correspondingly high. Thus, the downstream electronics, for example a control device in a motor vehicle, can continue to operate for a relatively long period of time after the power supply 19 of the analog sensor 1 has been interrupted.

If the power supply 19 has then been reinstated, the analog sensor is generally measurement-ready again very quickly and it can provide signals corresponding to the physical variable to be measured to the signal line 7 and therefore actuate the downstream electronics in the motor vehicle.

FIG. 2 shows a digital sensor 2. The digital sensor 2 comprises a sensor element 3, a digital part 10, a sample-and-hold stage 11 and an output stage 12. The digital sensor 2 can further contain other digital and analog circuit elements. The sensor element 3 detects a physical variable and provides measured values corresponding to the variable in analog form.

In general, the measured values in the form of an electrical voltage, which is proportional to the measured variable, are made available. This electric voltage is converted in the digital sensor 2 from its analog form into a digital form, which takes place in the digital part 10. For this purpose, an analog-to-digital converter is provided in the digital part 10. The mode of operation of analog-to-digital converters is known to a person skilled in the art. The analog-to-digital converter makes available a digital signal which is proportional to the analog input variable. This digital signal is provided by the digital part to the sample-and-hold stage. The digital signal is stored in the sample-and-hold stage until a new digital signal is made available by the digital part 10. The output stage 12 transmits the digital signal over the signal line 7 to downstream electronics, for example a control device in a motor vehicle.

The power supply line 4 connects the digital sensor 2 to a power supply 19. Electrical energy is supplied to the sensor element 3, the digital part 10, the sample-and-hold stage 11 and the output stage 12 with the aid of the power supply line 4. Even in the case of the digital sensor 2, the power supply line 4 is connected to a first capacitor 5, which stores electrical energy and therefore acts as storage 5 for storing electrical energy. In addition to a capacitor 5, other storage 5 for storing electrical energy are also conceivable, for example batteries or rechargeable batteries. In the event of failure of the power supply 19, the electrical energy stored in the storage for storing electrical energy can be used to supply electrical energy to the sensor element 3, the digital part 10, the sample-and-hold stage 11 and the output stage 12. Thus, the digital sensor 2 can still continue to operate and provide measured values for a certain period of time even in the event of a failure of the power supply 19 until the energy in the storage 5 for storing the electrical energy, i.e., in this exemplary embodiment in the first capacitor 5, has also been exhausted.

Contrary to the solution for the analog sensor 1, which was illustrated in FIG. 1, a second capacitor 8 in the signal line 7 of the digital sensor 2 cannot transmit signals that correspond to the last measured value over the signal line 7 to the downstream vehicle electronics after failure of the sensor element 3. The signals transmitted from the digital sensor 2 via the signal line 7 to the downstream vehicle electronics are exclusively digital signals, i.e., bit sequences, which cannot be reinstated by the second capacitor 8. The second capacitor 8 in the signal line 7 merely has the function of interference suppression for the signal line 7 in the case of the digital sensor 2, whereby the time constant for the second capacitor 8 in the signal line 7 of the digital sensor 2 is approximately 10 to 100 μsec, and the capacitance of this capacitor is correspondingly low. After failure of the power supply 19 and exhaustive consumption of the stored electrical energy in the first capacitor 5, the digital sensor 2 completely breaks down and does not provide any information over the signal line to the downstream motor vehicle electronics. The downstream motor vehicle electronics in such a case need to be controlled in an emergency program, which results in substantially impaired actuation of the equipment to be controlled, for example, of the internal combustion engine. If the sensor element 3 of the digital sensor is in the form of a mass flow sensor element 13, for example, which operates in accordance with the hot film principle, this sensor element 3, 13 consumes a very large amount of electrical energy, whereby the electrical energy stored in the storage 5 for storing electrical energy is exhausted very soon after the power supply 19 is interrupted or fails. Thus, for example a digital mass flow sensor can only continue to operate for a very short time until it discontinues its operation completely after a power failure.

Even if thereafter the power supply 19 is reinstated, the distal sensor 2 first needs to be initialized again, wherein more time elapses before a signal proportional to the variable to be measured is made available over the signal line 7. Thus, failures of the power supply 19 have a much more long-term effect on a digital sensor 2 than on an analog sensor 1.

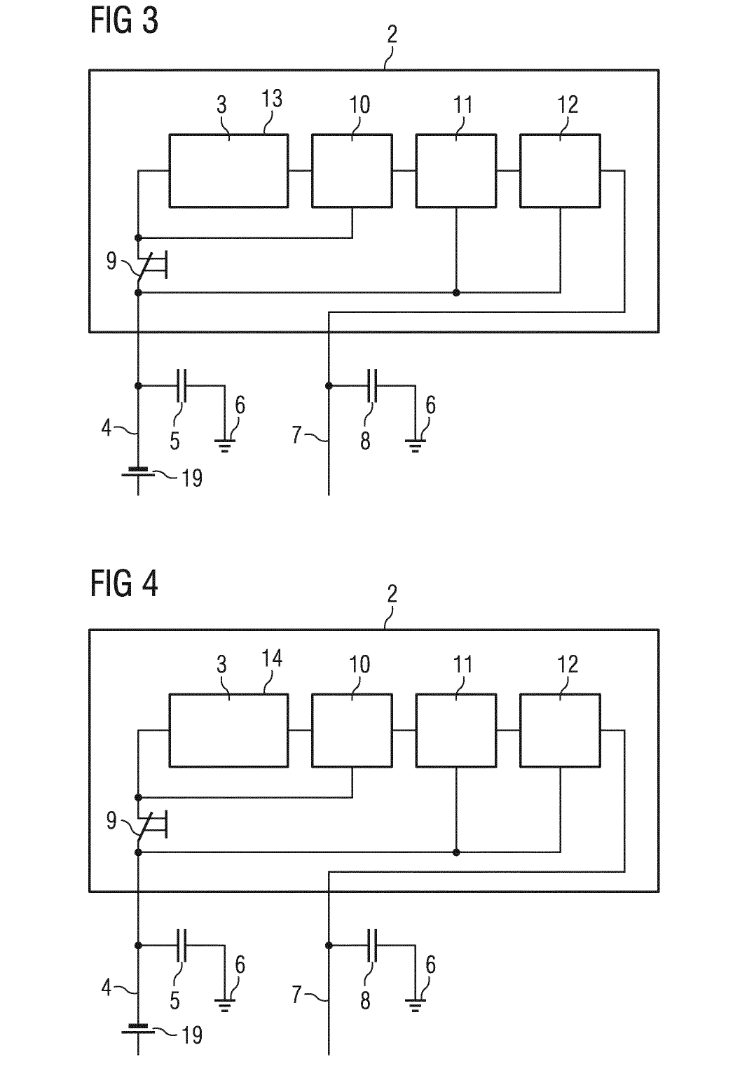

These disadvantages are avoided by a digital sensor 2 illustrated in FIG. 3.

FIG. 3 shows a digital sensor 2 according to the invention comprising a sensor element 3, a digital part 10, a sample-and-hold stage 11 and an output stage 12. The sensor element 3 is in the form of a mass flow sensor element 13 in this example. Such mass flow sensor elements 13 are known and are described in EP 374 352 A1 and EP 866 950 B1, for example. Modern mass flow sensor elements 13 are manufactured micromechanically and can be formed as part of an integrated circuit together with the digital part 10, the sample-and-hold stage 11 and the output stage 12 on a single silicon chip. In the case of the digital sensor 2, again the power supply line 4 which connects the digital sensor 2 to the power supply 19 can again be seen. The storage 5 for storing electrical energy is in the form of a capacitor on the power supply line 4. Furthermore, it can be seen that there is a switch 9 in the power supply line 4, which switch is generally in the form of an electronic switch and has the task of disconnecting components with a high current consumption, such as the sensor element 3, for example, from the storage 5 for storing the electrical energy in the event of a failure of the power supply. The switch 9 therefore ensures that electrical energy is continued to be supplied to only those component parts of the digital sensor 2 that are absolutely necessary for continuing to transmit the last measured value stored in the sample-and-hold stage 11, after a failure of the power supply 19, to the signal line until the failure of the power supply 19 is at an end and a new measured value is stored in the sample-and-hold stage 11 of the sensor element 3. In this example, the switch 9 disconnects the mass flow sensor element 13 and the digital part 10 from the storage 5 for storing electrical energy in the event of failure of the power supply. Thus, the storage 5 for storing electrical energy need only to continue to supply electrical energy to the sample-and-hold stage 11 and the output stage 12. Since the sample-and-hold stage 11 and the output stage 12 consume comparatively little electrical energy, the storage 5 for storing electrical energy can ensure the power supply to the sample-and-hold stage 11 and the output stage 12 for a relatively long period of time after failure of the power supply 19. The measured value determined last by the sensor element 3 and stored in the sample-and-hold stage 11 can therefore be made available for a long period of time in the signal line 7 and can be used for activating a downstream electronic circuit. This downstream electronic circuit can be, for example, a motor control device in a motor vehicle. The second capacitor 8 shown here again only serves to improve the electromagnetic properties of the signal line 7 and does not have any influence on the maintenance of binary output signals in the signal line 7.

FIG. 4 shows a digital sensor 2 having all of the features of the digital sensor shown in FIG. 3, wherein the sensor element 3 is in the form of a gas sensor element 14 in FIG. 4. The sensor element can also be in the form of a pressure sensor element, a temperature sensor element, a position sensor element or a rotation speed sensor element. It is also conceivable for a combination of two or more of the previous mentioned sensor elements to be formed on the digital sensor.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. A digital sensor (2) comprising:
a sensor element (3) configured to determine a measured value of a downstream electronic circuit;
a digital part (10) configured to digitize and/or evaluate the measure value;
a sample-and-hold stage (11) configured to store the measured value;
an output stage (12) configured to make available the stored measure value from the sample-and-hold stage (11) to a signal line (7);
at least one storage element (5, 8) configured to store electrical energy; and
a power supply (19) configured to supply electrical energy, via a power supply line (4), to the sensor element (3), the digital part (10), the sample-and-hold stage (11), the output stage (12) and the at least one storage element (5),
wherein the sensor (2) is configured to make available, in digital form, the measured value of the downstream electronic circuit, such that, in the event of a failure of the power supply (19), current is supplied to the sample-and-hold stage (11) and the output stage (12) by the at least one storage element (5) such that the measured value last stored in the sample-and-hold stage (11) is made available by the output stage (12) in the signal line (7) until the failure of the power supply (19) has come to an end and a new measured value is stored in the sample-and-hold stage (11), and wherein, in the event of a failure of the power supply (19), no electric current is supplied to the sensor element (3) from the at least one storage element (5).

12. The digital sensor (2) as claimed in claim 11, wherein the sensor element (3) is a mass flow sensor element (13).

13. The digital sensor (2) as claimed in claim 11, wherein the sensor element (3) is a gas sensor element (14).

14. The digital sensor (2) as claimed in claim 11, wherein the sensor element (3) is a pressure sensor element (15).

15. The digital sensor (2) as claimed in claim 11, wherein the sensor element (3) is a temperature sensor element (16).

16. The digital sensor (2) as claimed in claim 11, wherein the sensor element (3) is a position sensor element (17).

17. The digital sensor (2) as claimed in claim 11, wherein the sensor element (3) is a rotation speed sensor element (18).

18. The digital sensor (2) as claimed in claim 11, wherein the at least one storage element (5) is arranged in or on the power supply line (4).

19. The digital sensor (2) as claimed in claim 11, wherein the at least one storage element (5) comprises at least one capacitor.

20. The digital sensor (2) as claimed in claim 18, further comprising a switch (9), arranged in the power supply line (4), configured to, in the event of a failure of the power supply (19), connect exclusively the sample-and-hold stage (11) and the output stage (12) to the at least one storage element (5).
